(19) United States
(12) Patent Application Publication
(10) Pub. No.: US 2018/0164967 A1
(43) Pub. Date: Jun. 14, 2018

(54) BROWSER-BASED GENERATION OF NEW LOGICAL DATA OBJECTS

(71) Applicant: SAP SE, Walldorf (DE)

(72) Inventors: Pradeep Kumar N, Bangalore (IN); Prabhat Raman, Cupertino, CA (US); Sreekanth K, Kottayam (IN); Jitender Bhatia, Bangalore (IN); Horst Schaude, Kraichtal (DE); Bhavani Shankar Indrakanti, Visakahapatnam (IN); Abhishek Kunuthur Naga, Bangalore (IN); Duroc Marie Denise Duroc Andre, Puducherry (IN); Prabhu Mallappa Yandigeri, Bangalore North (IN); Manjunath Jn, Bangalore (IN); Prathiba Aravind, Bangalore (IN); Nikita Jain, Bilaspur (IN); Sameer Kumar, Bangalore (IN); Sasi Kanth Velagaleti, Vijayawada (IN); Aravinda Pantar, Karlsruhe (DE)

(73) Assignee: SAP SE, Walldorf (DE)

(21) Appl. No.: 15/379,338

(22) Filed: Dec. 14, 2016

(51) Int. Cl. G06F 3/0484; G06F 17/30

(52) U.S. Cl. CPC G06F 3/0484; G06F 3/04842; G06F 17/30864

(57) ABSTRACT

A method of customizing a computing environment comprises providing a browser-based application to a user, receiving instructions from the user via the browser-based application to define a custom logical data object, defining the custom logical data object in a system backend in accordance with the instructions, and generating a user interface comprising the custom logical data object within the browser-based application.

### BACKGROUND

Customers have a need to extend or adapt source systems to meet new and changing needs. Providing customers with a tool or other utility to develop solutions for such needs would allow development to occur with greater speed, accuracy and flexibility. At the same time, such a tool or utility needs to address that users of different types, such as customers and partners they task with assisting them with development, would benefit from a streamlined workflow. Current methods require using multiple systems having different logins, completing routine steps multiple times and do not show steps of the development process in a convenient view.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one implementation, a method of customizing a computing environment comprises providing a browser-based application to a user, receiving instructions from the user via the browser-based application to define a custom logical data object, defining the custom logical data object in a backend in accordance with the instructions, and generating a user interface comprising the custom logical data object within the browser-based application.

In another implementation, one or more computer readable media store instructions that, when executed by one or more processors, cause the one or more processors to perform a method that comprises receiving a request made via a web application with a user interface to generate a new logical data object, defining the new logical data object in a system backend according to parameters specified via the web application, and generating a new user interface element corresponding to the new logical data object in the same user interface.

In another implementation, a browser-based tool accessible from a customer system comprises a user interface configured to receive input to define a custom logical data object in a source system backend connected to the customer system and to enable the custom logical data object in the customer system.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram depicting an example system for using and generating logical data objects.

FIG. 2 is a diagram showing a representative logical data object schema.

FIG. 3 is a flowchart depicting an example method for generating a logical data object via a web application.

FIG. 4 is a diagram depicting an example user interface for generating a logical data object via a web application.

FIG. 5 is a diagram depicting an example user interface showing a tool within the same user interface being selected.

FIG. 6 is a diagram depicting an example user interface showing a new logical data object being created or generated.

FIG. 7 is a diagram depicting an example user interface showing another type of logical data object being generated.

FIG. 8 is a diagram depicting an example user interface showing that the logical data object has been published, and that a file for the logical data object is being downloaded.

FIG. 9 is a diagram depicting an example user interface showing the downloaded file for the logical data object.

FIGS. 10-12 are diagrams depicting example user interfaces showing a new logical data object and a new instance thereof being generated.

FIG. 13 is a diagram depicting a representative user interface of a local copy of a web service file.

FIG. 14 is a diagram depicting a representative user interface of a third party application used for testing the web service.

FIG. 15 is a diagram of a representative user interface showing that the web service has been created using the web application user interface.

FIG. 16 is a block diagram depicting another example system for using and generating logical data objects.

FIG. 17 is a block diagram of an example computing system in which the described embodiments can be implemented.

FIG. 18 is an example cloud computing environment that can be used in conjunction with the described technologies.

### DETAILED DESCRIPTION

### Example 1—Overview

Users seek to create new logical data objects (LDOs) in more straightforward ways so that development of such new objects can be accomplished more quickly, with greater accuracy and with more flexibility, both in terms of what classes of users may take part in the development and how the new LDOs are deployed among various users. Described below is a new browser-based utility or tool permitting customers and their designated partners to extend system functionality by creating new or custom LDOs, testing them and deploying them using the same user interface.

Some customizable web applications can be configured to generate user interface components, through which data stored in created and/or modified data structures can be accessed and manipulated. However, in such applications, access to the created and/or modified data structures is typically limited to the use of the application's user interface. Customized data structures and associated logical operations are thus isolated to the application where they are defined and cannot be accessed by external applications or integrated into a broader enterprise solution. At least some of the technologies described herein address these problems by generating consumable web services based on logical data objects (LDOs) and/or extension nodes, and by processing web service requests targeting operations associated with LDOs and/or extension nodes. Generally speaking, web services are self-contained and self-describing application functionalities that can be processed through open internet standards.

Various technologies described herein can be used to create LDO web service definitions. A design-time application can be provided which comprises a user interface that can be used to create a LDO web service definition. The user interface can comprise one or more UI components that can be used to define a view of a LDO, comprising one or more nodes and/or data elements. The user interface can be used to define one or more service operations associated with the LDO view. A web service definition can be created that includes the view of the LDO and the one or more service operation definitions.

Various technologies described herein can be used to generate LDO web services. A repository service can receive a web service definition and store the web service definition in a design document store. A runtime engine can generate a LDO web service based on the received web service definition. The runtime engine can register the generated service with an externally facing service endpoint. The runtime engine can be configured to receive web service requests over the service endpoint and process the requests using the generated service.

### Example 2—Example Logical Data Object

In any of the examples described herein, a logical data object (LDO) can contain a definition of a hierarchical data structure and definitions of one or more logical operations that can be performed using portions of the hierarchical data structure. In some cases, a logical data object may be referred to as a “business object” and can take any number of forms including intelligence or performance management components such as those implemented in software technologies of SAP BusinessObjects, Oracle Hyperion, IBM Cognos, and others. But the use of logical data objects in computer applications is not limited to “business” scenarios. Logical data objects can be used to define a particular application and/or problem domain space. Aspects and artifacts of a given problem domain can be defined using the hierarchical data structure and various portions of these aspects and/or artifacts can be associated directly with definitions of relevant logical operations.

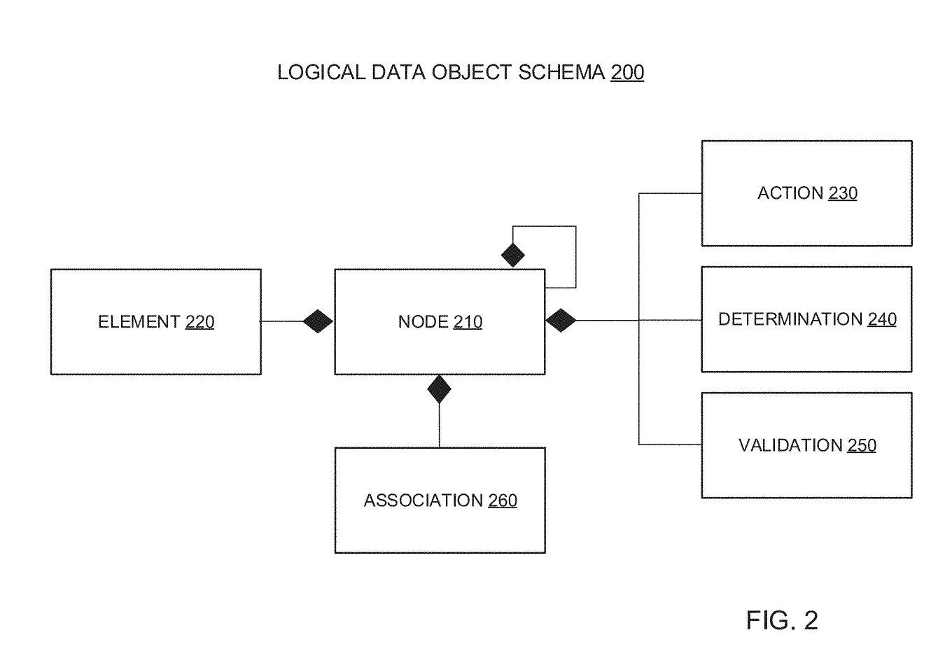

FIG. 2 is a diagram of an example LDO schema 200. A node 210 can contain one or more data elements 220. A data element 220 can contain an identifier, such as a name, and an associated value. In at least some embodiments, the data element 220 can be associated with a data type that restricts and/or validates the type of data that can be stored as a value of the data element 220. A node 210 can contain one or more child nodes 210 (also referred to as sub-nodes), which can themselves contain additional data elements 220. Combinations of sub-nodes 210 and data elements 220 can be used to define a hierarchical data structure of multiple nodes 210.

Each node in the LDO can be associated with one or more actions 230. An action can comprise a definition for a logical operation that can be performed using the node 210 with which it is associated. The action 230 can also contain an identifier that can be used to invoke the action 230. Each node in the LDO can be associated with one or more determinations 240. A determination 240 can contain a definition for a logical operation that can be automatically executed using the node 210 with which it is associated when some trigger condition is fulfilled. Example trigger conditions can include a modification of the associated node 210, a modification of the data element 220 of the associated node 210, the creation of a data element 220 of the associated node 210, etc. A logical operation defined by an action 230 or a determination 240 can comprise instructions to create, update, read, and/or delete one or more data elements 220 and/or one or more sub-nodes.

Each node in the LDO can be associated with one or more validations 250. A validation 250 can contain a definition of one or more data integrity rules and/or checks. The one or more data integrity rules and/or checks can be performed when the associated node 210 and/or one or more data elements 220 of the associated node 210 are created, modified, and/or deleted. Any such operation that does not satisfy the one or more data integrity rules and/or checks can be rejected.

Each node in the LDO can be associated with one or more nodes from one or more other LDO's by one or more associations 260. An association 260 can contain an identifier for a node in another LDO that is associated with the node 210. Associations 260 can be used to define relationships among nodes and various LDOs. The Association 260, in at least some embodiments, contains an association type indicator that identifies a type of association between the node 210 and the node in the other LDO with which it is associated.

Although the action 230 is defined and associated with the node 210, when the action 230 is invoked, it targets an identified instance of the node 210 with which it is associated. Similarly, a determination 240 and/or validation 250 is defined and associated with the node 210, but can target an instance of the associated node 210 when it/they is/are invoked. Multiple instances of a given logical data object can be created and accessed independently of one another. Although the instances of the logical data object share a common schema, the data values stored in their respective node instances and data element instances can differ, as can the LDO instances that are associated by the associations 260. Additionally or alternatively, an instance of an association 260 can identify a particular instance of an associated node in another LDO instance. The identifier of a node instance can be an alphanumeric string that uniquely identifies the instance and, in at least some cases, can be used to look the instance up and/or retrieve data associated with the instance. Exemplary identifiers include numerical values and universally unique identifiers. Other types of identifiers are also possible.

### Example 3—System for Generating a New LDO

In any of the examples herein, a system can be provided for generating a new LDO.

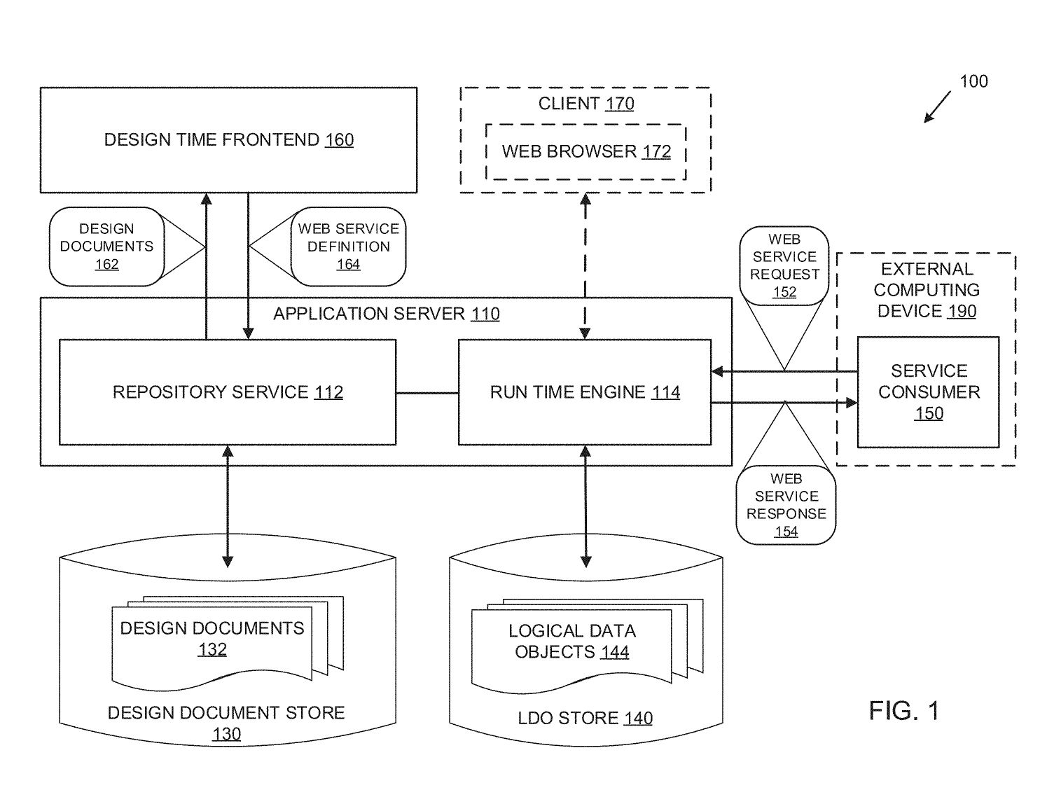

FIG. 1 is a block diagram depicting an example system 100 in which user requests to generate a new LDO are received and processed. An application server 110 comprises a repository service 112 and a runtime engine 114. The repository service 112 is configured to receive a web service definition 164 from a design time front-end 160. The web service definition 164 can define one or more web service operations that can be performed using instances of a LDO, such as one of the logical data objects 144 in the LDO store 140. The repository service 112 can store the web service definition 164, such as in a design document store 130.

The runtime engine 114 is configured to generate a logical data object web service interface based on the received web service definition 164. Generating the logical data object web service interface can comprise registering a unique end point identifier that is associated with the web service definition 164. In at least one embodiment, the identifier can be provided as part of the web service definition 164. In a different embodiment, the end point identifier can be generated entirely, or in part, by the runtime engine 114. The runtime engine 114 is configured to receive a web service request 152 from a service consumer 150. The web service request 152 can comprise the end point identifier registered by the runtime engine 114 that is associated with the web service definition 164. The runtime engine 114 can determine that the end point identifier contained within the web service request 152 is the same end point identifier associated with the web service definition 164 and can process the web service request 152 using the web service definition 164.

In one embodiment, the web service definition 164 is used by the runtime engine 114 to generate a logical data object web service that is then used by the runtime engine 114 to process the web service request 152. The runtime engine 114 can generate the logical data object web service based on the web service definition 164 when the web service definition 164 is received by the repository service 112. Alternatively or additionally, the runtime engine 114 can generate the logical data object web service after web service request 152 is received. For example, the runtime engine 114, after determining that the end point identifier is associated with the web service definition 164, can provide an identifier of the web service definition 164 to the repository service 112 as part of a request to retrieve the web service definition 164. The repository service 112 can use the provided identifier to retrieve the web service definition 164 from the design document store 130. In a particular embodiment, all or part of the end point identifier is used as the web service definition identifier that is used to retrieve the web service definition 164 from the design document store 130.

The web service request 152 can comprise an operation identifier associated with one of the web service operations defined in the web service definition 164. The runtime engine 114 can determine which web service operation is associated with the operation identifier and can then process the web service request, at least in part, by performing the identified operation using one or more instances of a logical data object. For example, as part of processing the web service operation, the runtime engine 114 can manipulate and/or retrieve one or more of the logical data objects 144 in the logical data object store 140.

After the runtime engine 114 has finished processing the web service request 152, the runtime engine 114 can generate a web service response 154 and transmit the response back to the service consumer 150. The web service response 154 can contain a result of the web service operation. For example, in a case where the web service operation comprised retrieving one or more instances of a logical data object, the web service response 154 can contain all or part of the retrieved logical data object instances.

In at least one embodiment, the web service definition 164 identifies a particular logical data object of the logical data objects 144 in the logical data object store 140. For example, a logical data object can have a unique identifier and/or name that can be used to identify it. The runtime engine 114 can be configured to associate a logical data object web service generated using the web service definition 164 with the identified logical data object. The runtime engine 114 can limit the scope of any web service operations to instances of the identified logical data object. For example, if the web service request 152 identified an endpoint associated with the web service definition 164, but comprised a request to perform a web service operation on a logical data object other than the logical data object associated with the web service, the runtime engine 114 can be configured to reject the request to perform the web service operation. In a further embodiment, the web service response 154 can contain a message indicating that the web service request is not processed.

In at least some embodiments, the runtime engine 114 can be configured to generate a web service definition schema based on the web service definition 164. Service consumer 150 can transmit a request to the runtime engine 114 (not shown), requesting the web service definition schema. The web service definition schema can contain one or more endpoint identifiers associated with the web service definition 164 and/or information about web service operations defined in the web service definition 164. In a particular embodiment, the web service definition schema is a Web Service Definition Language (WSDL) schema. However, other forms of schema definition are also possible. In one embodiment, the runtime engine 114 dynamically generates the web service definition schema based on the web service definition 164 after receiving the request for the schema from the service consumer 150. In a different embodiment, the runtime engine 114 can generate the web service definition schema upon receipt of the web service definition 164 by the repository surface 112. The service consumer 150 can be configured to dynamically generate one or more web service access modules based on the web service definition schema. In at least one embodiment, one of the one or more web service access modules is used to transmit the web service request 152 and to receive the web service response 154.

Optionally, the service consumer 150 can be part of an external computing device 190 that is configured to communicate with the application server 110 over a network. Although a single service consumer 150 is depicted, the runtime engine 114 can be configured to receive and process web service requests from multiple service consumers on one or more different computing devices.

Optionally, the example system 100 can comprise a client computing device 170 comprising a web browser 172. The runtime engine 114 can be configured to receive web requests, such as requests using the hypertext transfer protocol (HTTP), from the web browser 172 and to process those requests using one or more instances of one or more of the logical data objects 144 and/or one or more of the design documents 132. In such an embodiment, the logical data object web service generated based on the web service definition 164 can provide an alternative means of accessing the same one or more logical data objects. For example, instead of interacting with the runtime engine 114 by the web browser 172, service consumer 150 can be used to incorporate behavior encapsulated in the web service operations of the logical data object web service into one or more external applications.

The design time frontend 160 can be used to generate the web service definition 164. The design time frontend 160 is configured to retrieve one or more design documents 162, of the design documents 132 in the design documents store 130, from the repository surface 112. The design documents 162 can comprise metadata defining the logical data objects 144 and/or operations that can be performed using the logical data objects 144. The design time frontend 160 can comprise a user interface for presenting information contained within the design documents 162 to a user and receiving input from the user to define a logical data object web service comprising one or more web service operations to be performed using one or more instances of a logical data object. The design time frontend 160 can be configured to generate the web service definition 164 based on the received user input.

In a particular embodiment, the design time frontend 160 is part of a design time application running on a client computing device. In such an embodiment, the design time application can be configured to communicate with the application server 110 over a computer network using a network interface of the client computing device.

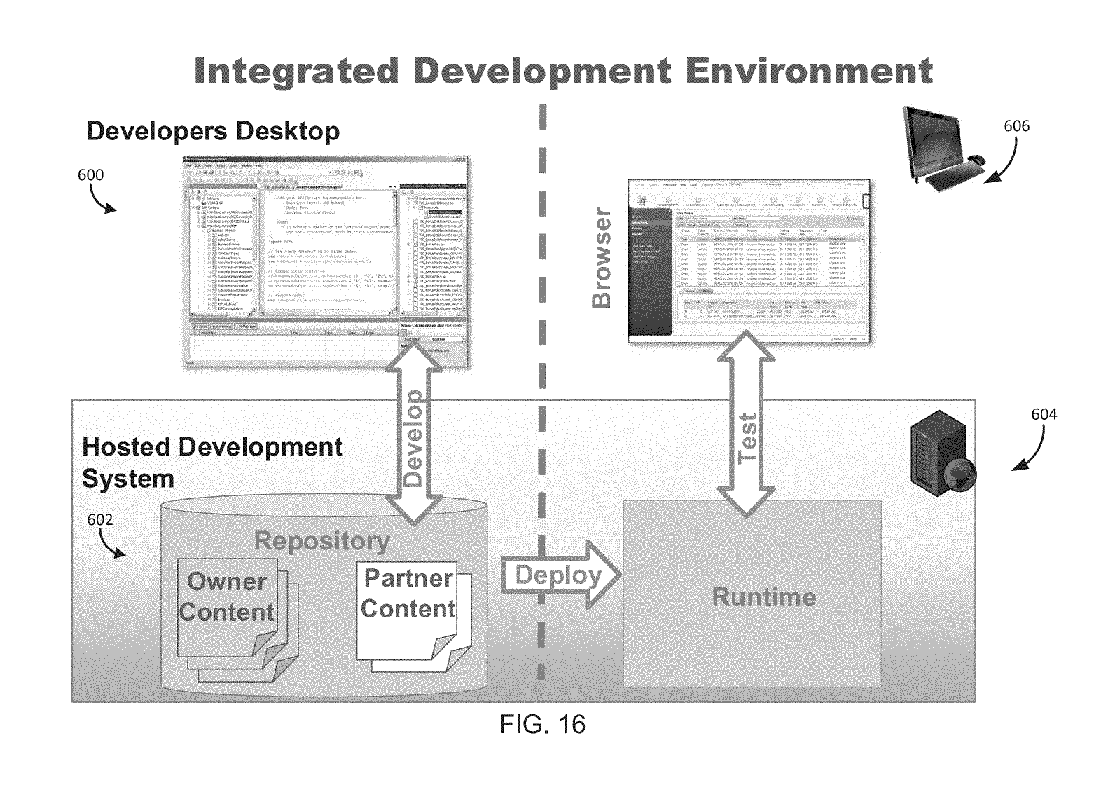

FIG. 16 is a block diagram depicting another example system for using and generating logical data objects. At 600, a developer's desktop is shown, representing a view seen by a user on a local computer seeking to complete a development task involving LDOs. The user connects to and logs into the hosted development system 602. The hosted development system includes a repository that can include, among other types of information, host content and partner (or user) content. The user's development coding is stored as partner content. Following development, the user's coding is deployed into a runtime environment 604 and executed. At 606, the browser represents a view seen by a customer (or other type of user) accessing the system, and can be used to test the development coding.

### Example 4—Method for Generating a New LDO

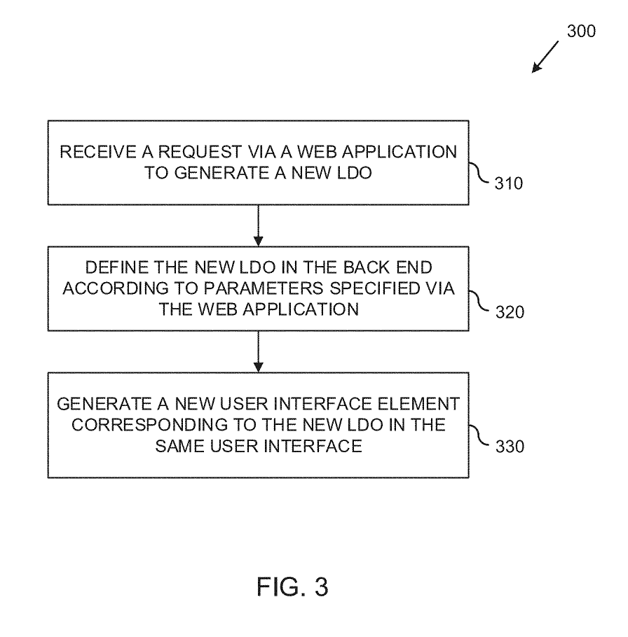

FIG. 3 is a flowchart depicting an example method 300 for generating a new LDO. Any of the example systems described herein can be used to perform the example method 300.

At 310, a request for a new LDO is received via a web application. The request is typically made by a user, such as by an authorized partner of the customer (in some cases, the customer itself is qualified to carry out development). The request is made via the same URL of the customer's system.

At 320, a new LDO is defined in the back end of the system in accordance with the request. The new LDO is defined in accordance with attributes specified by the user via the web application. According to one example, the new LDO is a new business object, and in particular a new solution. A solution is an entity of information consisting of servers, databases, systems, software components, and business scenarios and processes. The solution is a virtual container, where the production business processes and the related systems and software components information are documented.

In some cases, a LDO web service may be generated. Generating a LDO web service can comprise processing the one or more operation definitions in the LDO web service definition and creating one or more objects for use in performing the one or more service operations. In an embodiment where an operation definition comprises imperative instructions for performing a given operation, processing the operation definition can comprise interpreting and/or compiling the definition instructions to create one or more executable modules that, when executed, perform the operation. In an embodiment where an operation definition comprises declarative instructions that identify a built-in operation, one or more pre-existing executable modules may be associated with the built-in operation. In such an embodiment, the service operation can comprise a metadata representation that identifies the built-in operation and includes any parameter values included in the operation definition. In an embodiment where the LDO web service definition identifies a subset of nodes and/or data elements contained in the LDO, the generated LDO web service's access to the LDO can be limited to the identified subset of nodes and/or data elements. The generated LDO web service can be registered with a runtime engine that is configured to receive web service operation requests.

The web service operation request is received via a communication network using a web service protocol, such as the Simple Object Access Protocol (SOAP) or REpresentational State Transfer (REST). The endpoint identifier can comprise a unique identifier associated with the web service and/or a unique identifier associated with a server hosting the web service. In a particular embodiment, the endpoint identifier comprises a Uniform Resource Locator (URL), or a part of a URL. The operation identifier can comprise an identifier associated with the service operation in the web service definition, an identifier created for a service operation during the generation of the LDO web service, or some combination thereof.

A runtime engine with which the LDO web service is registered can extract the operation identifier from the web service operation request and locate an operation of the LDO web service that is associated with the operation identifier. In at least some embodiments, the operation identifier can comprise a unique identifier associated with the operation that is provided by the LDO web service definition. In a different or further embodiment, the operation identifier indicates an operation type of the requested operation.

In any of the example operations described herein, parameter values can be provided by an associated service operation definition. For example, rather than (or in addition to) being provided as part of the web service operation request payload, identifiers, data values, and/or parameter values can be provided as part of an operation definition in the LDO web service definition. When processing a requested operation, any such identifiers, data values, and/or parameter values can be retrieved from an associated operation definition and provided to the operation instead of (or in addition to) the data payload values.

Results of the operation can be transmitted in a web service response. In an embodiment where the web service operation request is received over a communication network using a web service protocol, the web service response can be transmitted over the communication network using the same protocol or different web service protocol. The result of the operation can vary depending on the type of operation that was performed.

### Example 5—User Interface for Defining a LDO Web Service

In any of the examples described herein, a web application user interface (UI) can be provided for generating a new LDO.

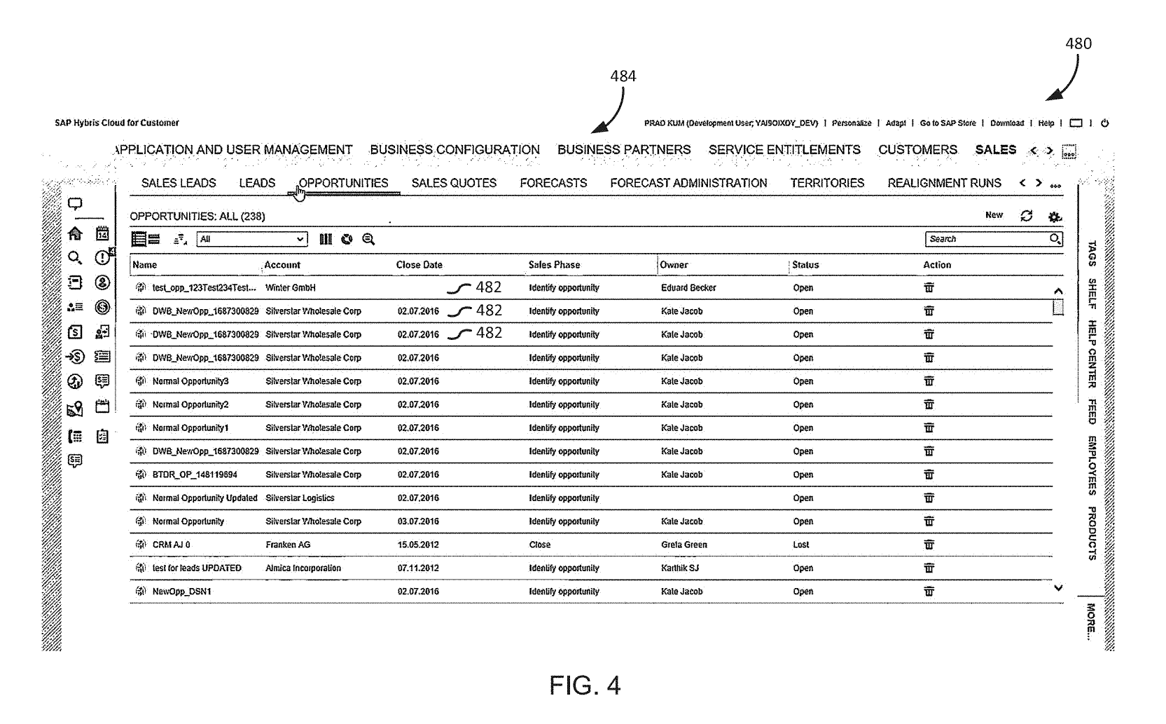

FIG. 4 is a diagram showing an application UI (also referred to as a screen) for opportunities displayed to a user. One category of a user is a customer, and another category of a user is a partner, as defined elsewhere in greater detail. In FIG. 4, a selection to display all opportunities 482 in the system has been selected. Each opportunity appears as a row and, in this example, is identified by name, account, close date, sales phase, owner, status and action. In some implementations, the screen of FIG. 4 is referred to as an opportunity work center 484.

In the scenario, the customer seeks to make an enhancement, which in this example is adding an element to a LDO in the back end, and modifying the user interface to show it as desired. For example, the customer may seek to have the owner's address to appear as an eighth column in the screen of FIG. 4. Adding the owner address is defined to be an extension of the opportunity LDO in the back end. Correspondingly, the user interface is modified to display the owner address.

In conventional approach, the partner is developing the revised opportunity in the partner's own tenant (i.e., sometimes referred to as a “test system”), and the customer's tenant is separate from the partner's tenant. Thus, the partner must log into a separate tool. Once development is believed to be complete, the partner will test the revised opportunity and conduct a quality review. Assuming the revised opportunity is satisfactory, the partner will then assemble and download it as a .zip file. The revised opportunity will be “shipped” to the customer's tenant and applied to the customer's system (i.e., sometimes referred to as the “productive system”).

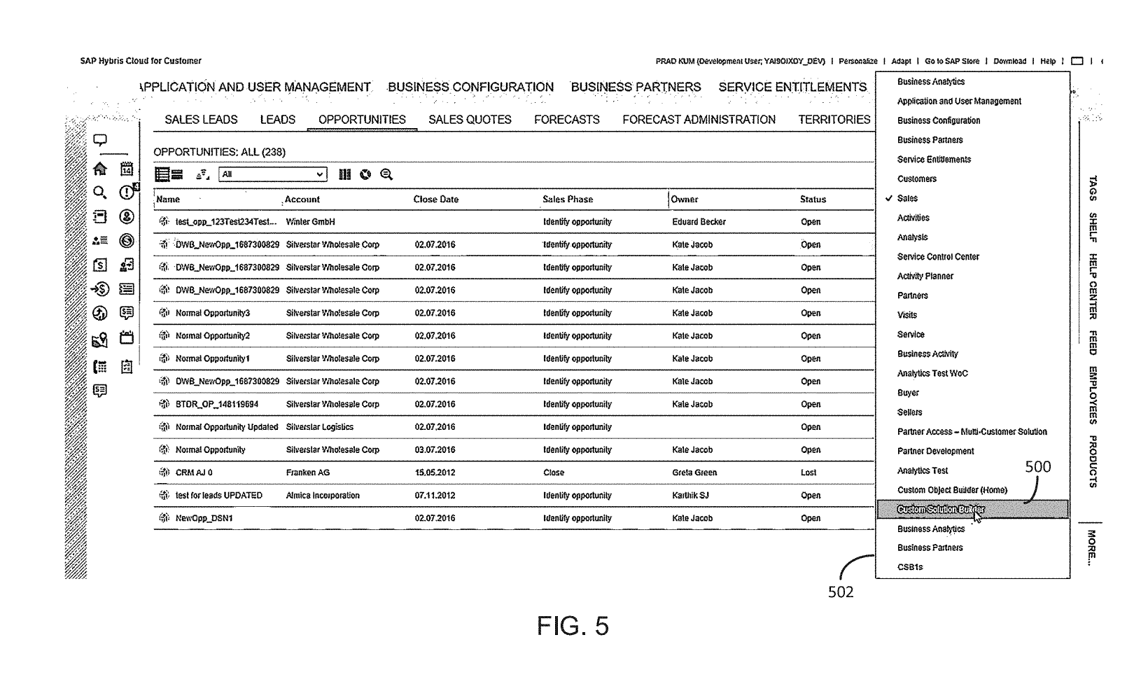

In FIG. 5, a new tool is available to the user having appropriate credentials (whether the user is a partner of the customer, the customer or another suitable party) for making enhancements within the application UI. In the example of FIG. 5, the new tool 500 is named Custom Solution Builder, and it has a structure similar to a container (sometimes referred to a “work center”). As used herein, a container is an entire runtime environment that includes an application and all of its dependencies, including libraries and other binaries and configuration files, “bundled into one package.” The new tool is shown (or exposed) in a menu 502 with other work centers. A work center can hold a group of related UIs (or “floor plans”).

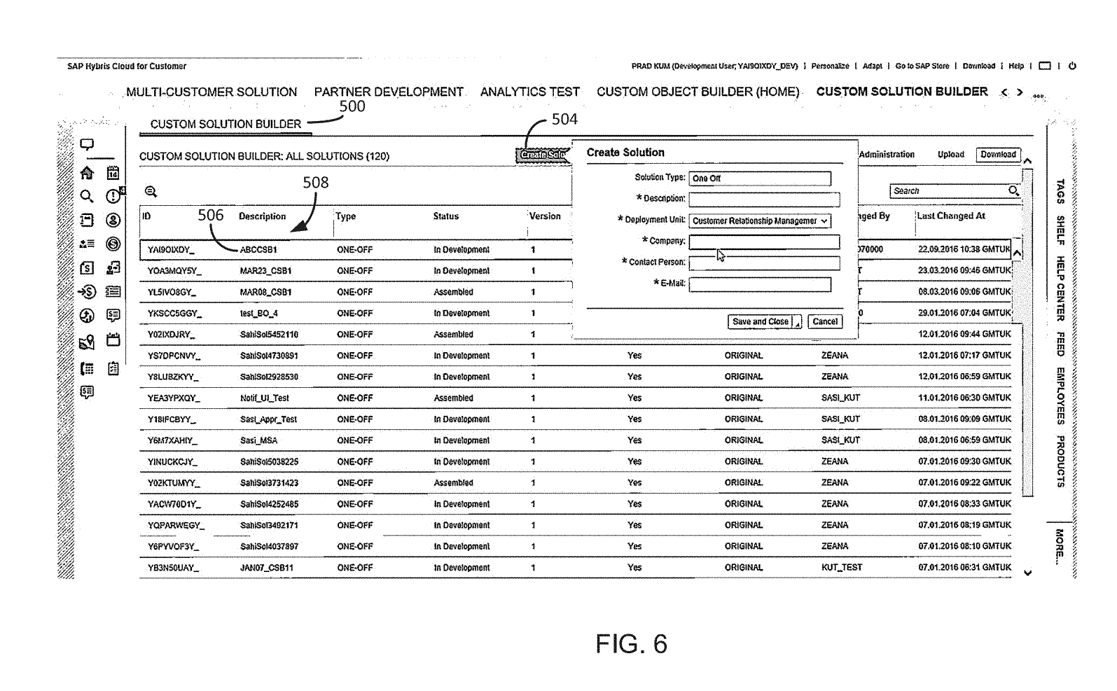

In FIG. 6, the Custom Solution Builder tool 500 has been selected and is displayed to the user. The user has selected Create Solution 504 and is in the process of developing a solution, which has been assigned “YAI9OIXDY” as the ID and been given the description ABCCSB1. In addition to Create Solution, the user also has the options of Create Patch, Activate, Enable/Disable, Delete, Session Administration, Upload and Download, which are described below.

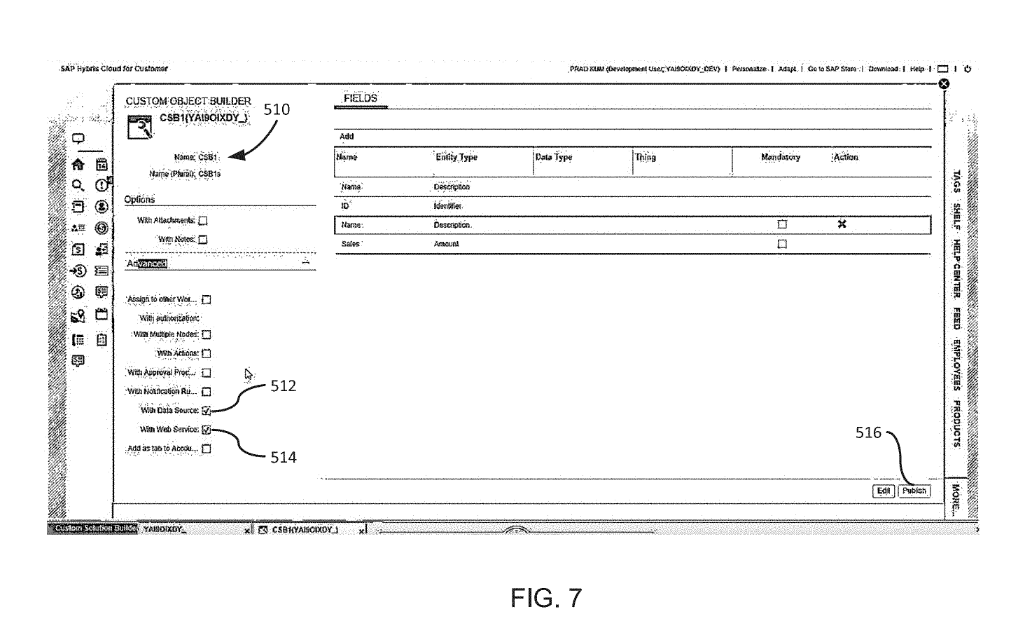

In addition, the user can also select the ABCCSB1 solution 506 in the Object Work List (OWL) 508 to access the Custom Object Builder work center shown in FIG. 7 to use the tool to create business objects. In this example, the user has created the business object CSB1 510. The business object CSB1 is “inside” or associated with the solution ABCCSB1. In the business object CSB1, the user has added three fields: ID, Name and Sales. Under the Advanced section, the user has checked the check boxes for “With Data Source” 512 and for “With Web Service” 514, and so when “Publish” 516 is selected for CSB1, the system will automatically create metadata, analytics, a web service with the new elements and a data source in the back end.

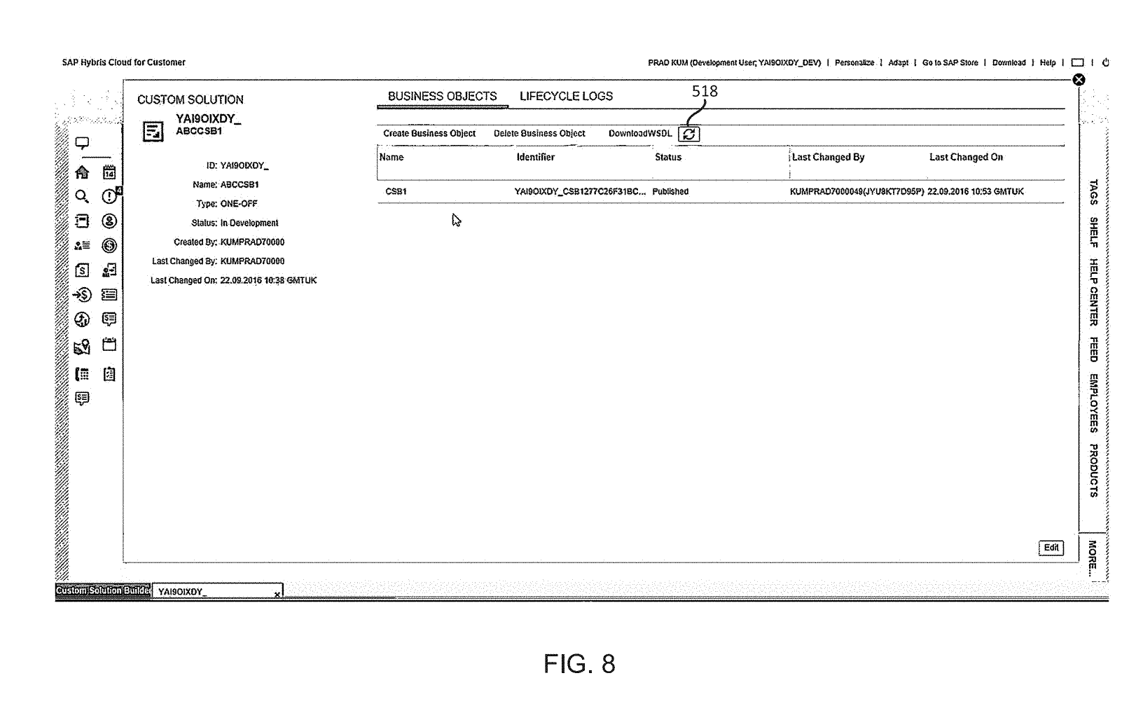

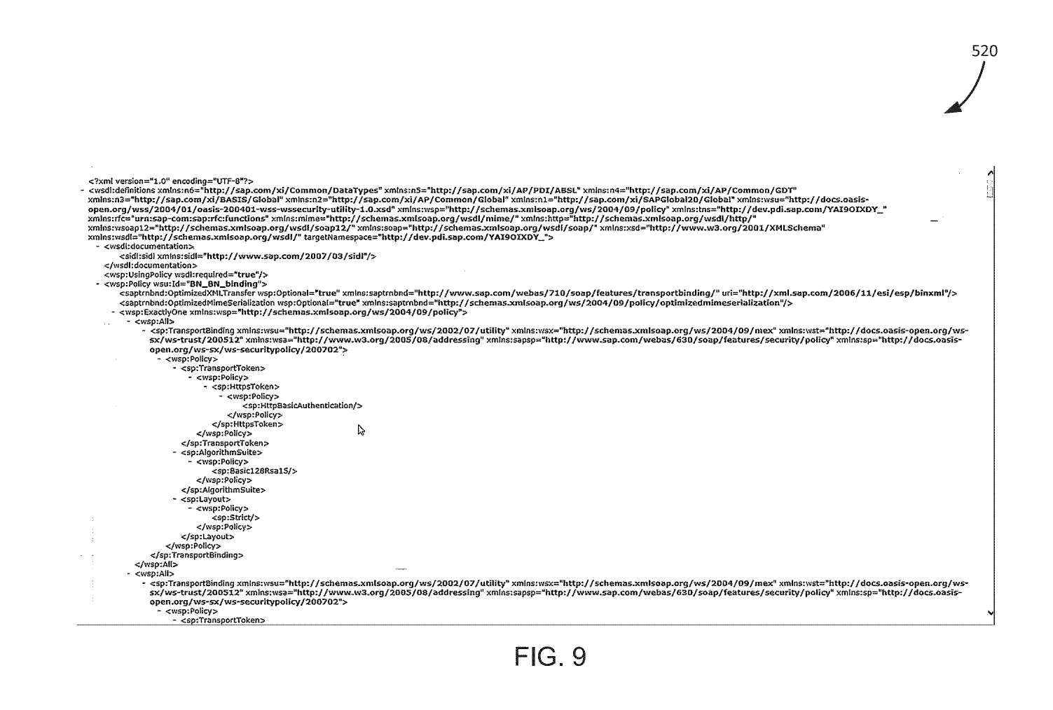

In FIG. 8, the status of the CSB1 is indicated as “Published,” and the user has initiated an operation to download a WSDL (Web Service Definition Language) file 518 corresponding to the new business object. In FIG. 9, the WSDL file 520 has been opened in a browser.

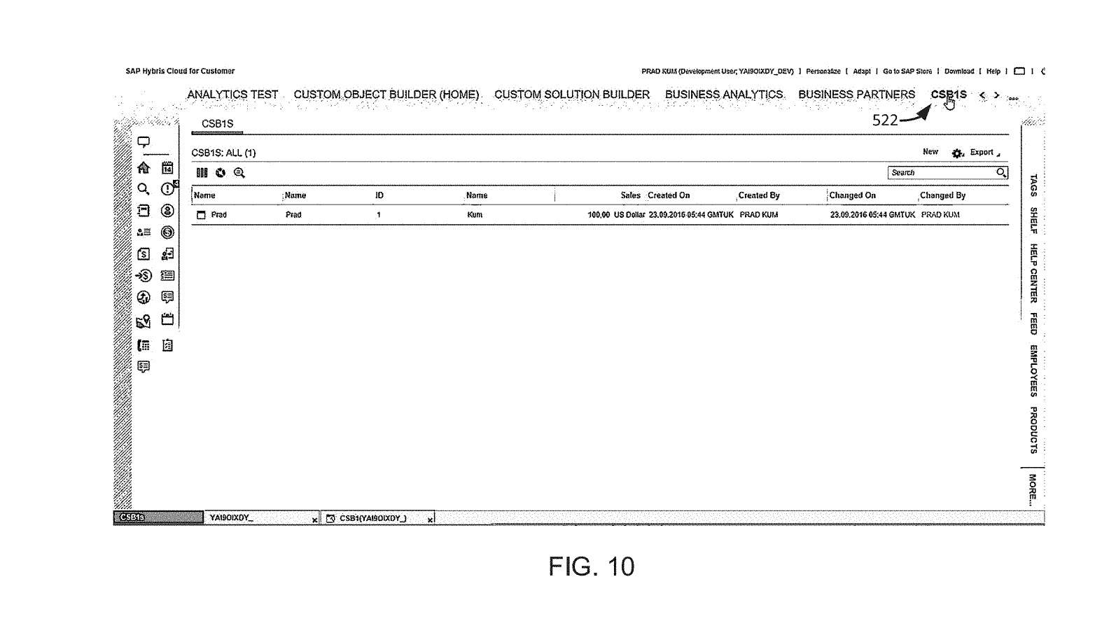

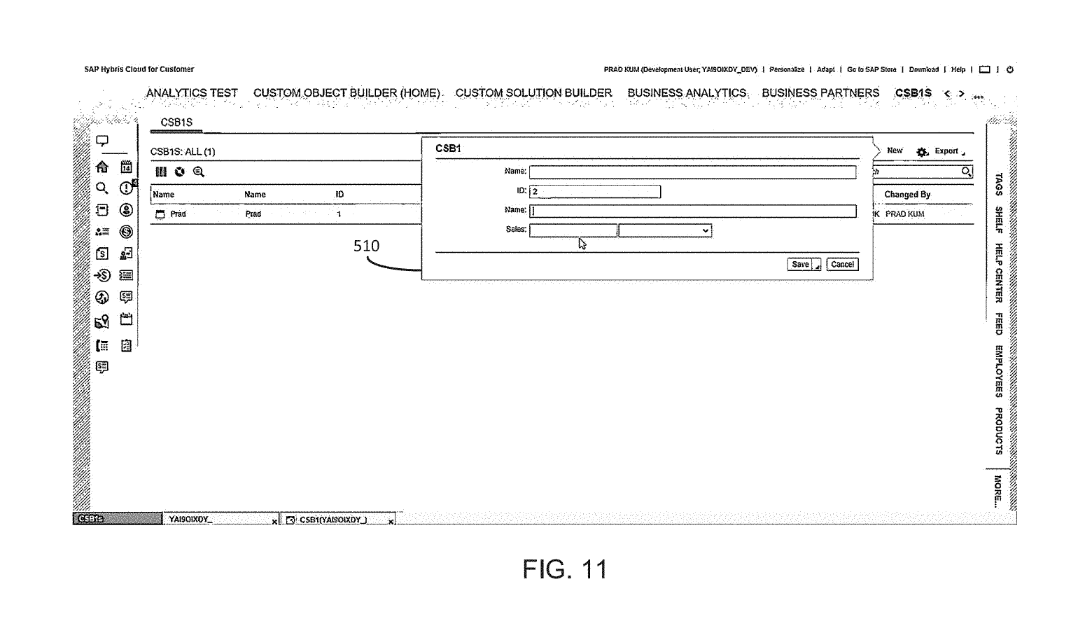

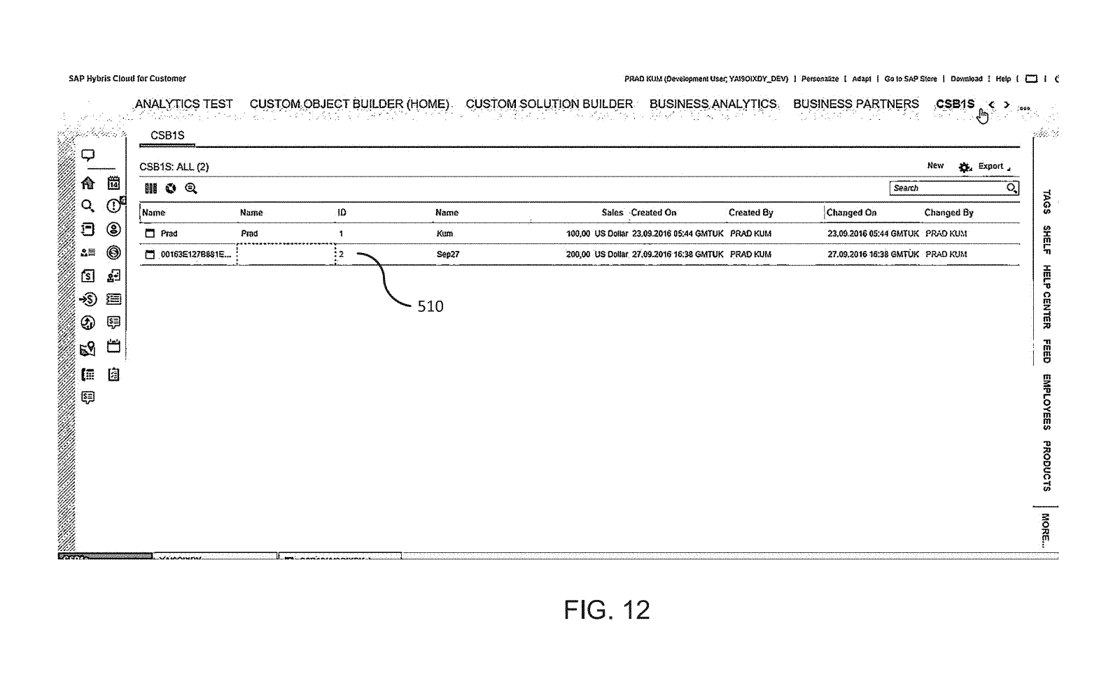

In FIG. 10, a new work center 522, CSB1S, has been created. If the user selects “New” as shown in FIG. 10, then the user is prompted to enter information for a new instance of the business object CSB1 with the previously set fields of ID, Name and Sales as shown in FIG. 11. Once completed, the entered information appears in FIG. 12 as entry 524 (i.e., entry “2”), so the user has thus conducted testing, as well as completed development, while remaining in the same UI.

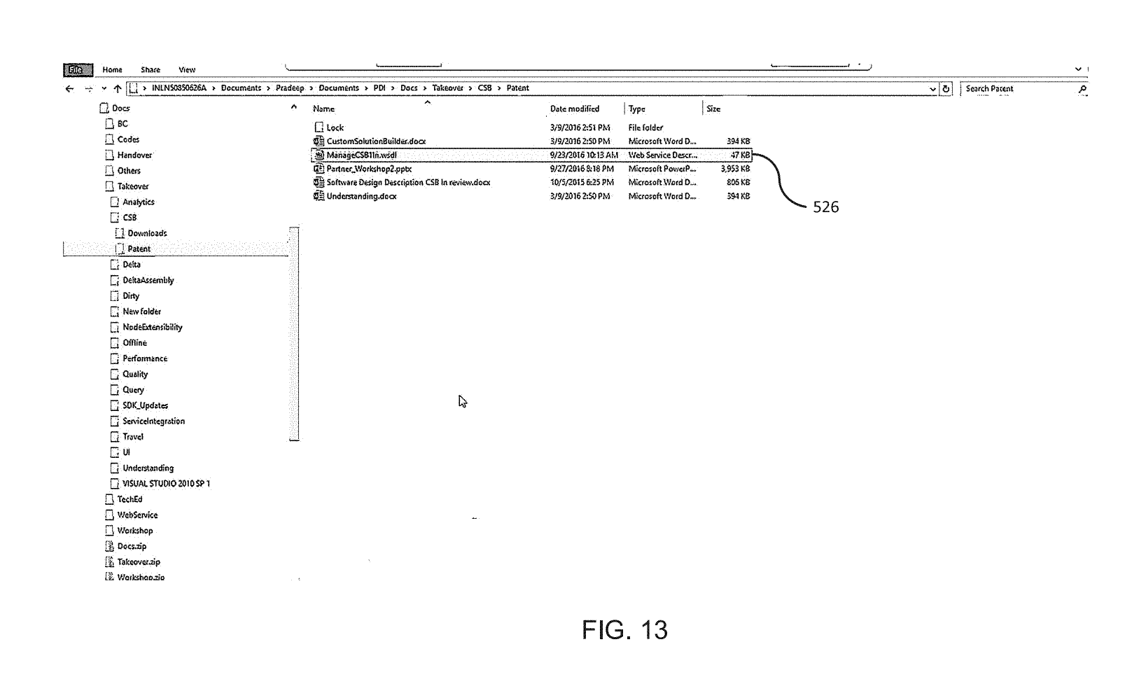

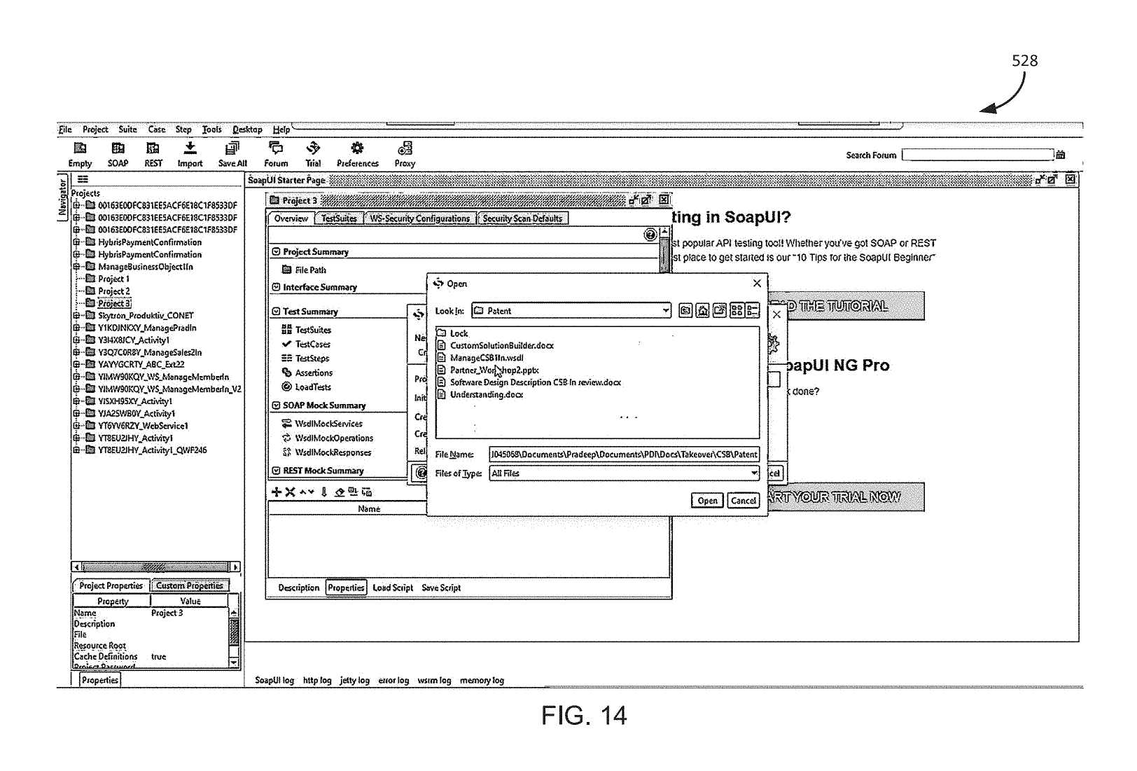

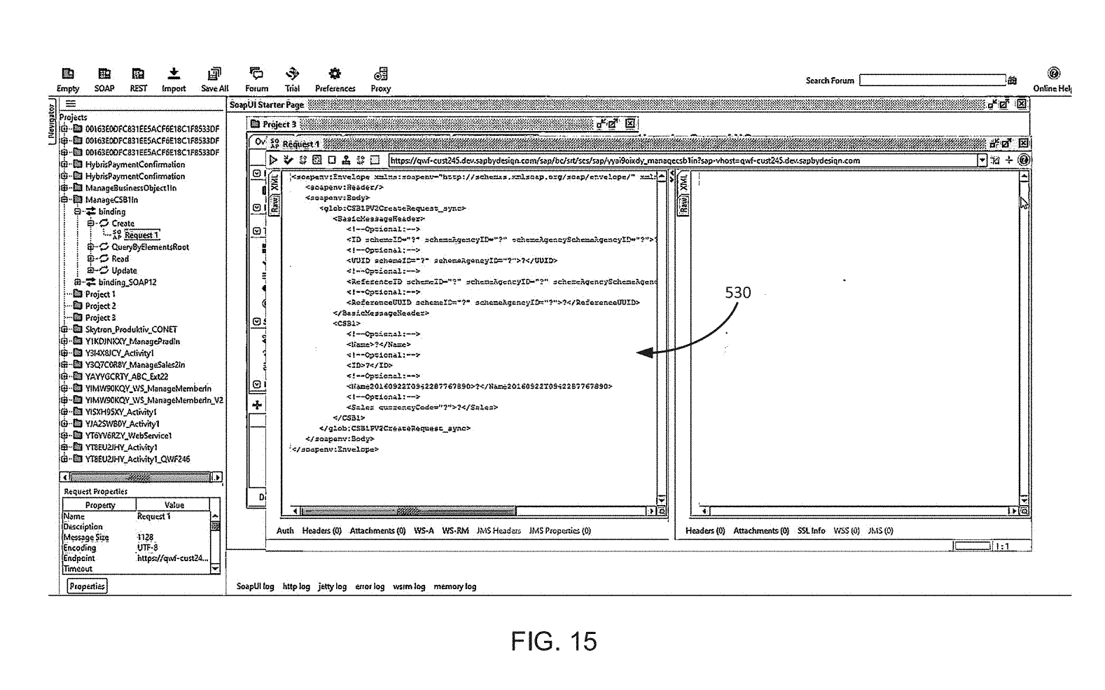

In FIG. 13, a local copy of downloaded WSDL file 526 is shown in the user's system. A third-party tool can be used to test the web service. For example, as shown in FIG. 14, SOAP UI 528 can be used to test the web service by selecting the downloaded ManageCSB1In.wsdl file as shown. In FIG. 15, it can be seen that the new web service 530 has been automatically created (simply because the “With Web Service” check box was selected), and any appropriate third-party tool can consume the enhanced business opportunity web service, which is in a standard protocol.

Details of the additional options described above are as follows. Delete Business Object is selected to select a solution from the Business Object OWL and delete the Business Object from the current solution. Create Patch is selected to select a solution from the OWL and create a patch solution for the selected solution (the name of the solution will be same but the ID would change for the newly created patch solution). If a patch solution already exists, then a new version of the patch solution would be created having a unique patch solution prefix. Activate is selected to activate the selected solution to create a solution and its contents based on the metadata contained in the zip file. Enable/Disable is selected to toggle enablement between the original and patch solutions. Only content of the enabled solution is available for consumption. Delete is selected to delete a solution from the OWL. Session Administration is selected to unlock the solution for others to use after changes to the solution have been made (at a given time, a user can work on only one solution). Session Administration lists all the partners in the system and the solution each partner is working on. Upload is selected to upload a zip file from the local disk into the current tenant. The zip file would be obtained from selecting the Download button and downloading the file, e.g., from another tenant. Download is selected to download a solution from the solution list in zip format (.zip file) to the local disk. The .zip file contains all the metadata of the solution, and the zip file can be uploaded into another tenant (following an upload, the solution would need to be activated to create the new solution in the other tenant.

Because the new tool is not a separate tool, but rather allows the user to complete development in the same web application user interface, access is simpler and easier. There is no need to install the new tool on the developer's system because the development is done through the web application user interface itself (in the above example, this is done in the Custom Solution Builder work center). Because the new tool is browser-based, development work can be carried on any compatible device (as opposed to be limited to the types of devices for which a suitable version of the tool was available). There is no need to update the new tool to ensure that the latest release and applicable patches are being used because the new tool is accessed through a URL. Web services and data objects can be generated directly by the user, which eliminates many steps and allows for a more classes of users to complete development. Testing a new solution made with the new tool is easier because no separate log in to the web application is necessary for integration testing (rather, the user is already logged into the web application). For similar reasons, setting up a demo is very straightforward using the new tool because only a single login is required and the same web application user interface is used.

The programming model includes extensibility/flexibility features that allow the development of extensions to logical data objects in a modification-free, lifecycle-stable, safe and easy way. In some cases, the required flexibility can be achieved with configuration and with declarative approaches (business configuration), such as using SAP Business By Design and products based on the By Design platform, among others.

A customer can request (and purchase) an add-on solutions that has been published by the solution provider in the SAP Store (for all customers that fulfill the software requirements, or for a limited set of customers).

### Example 6—Example Computing Systems

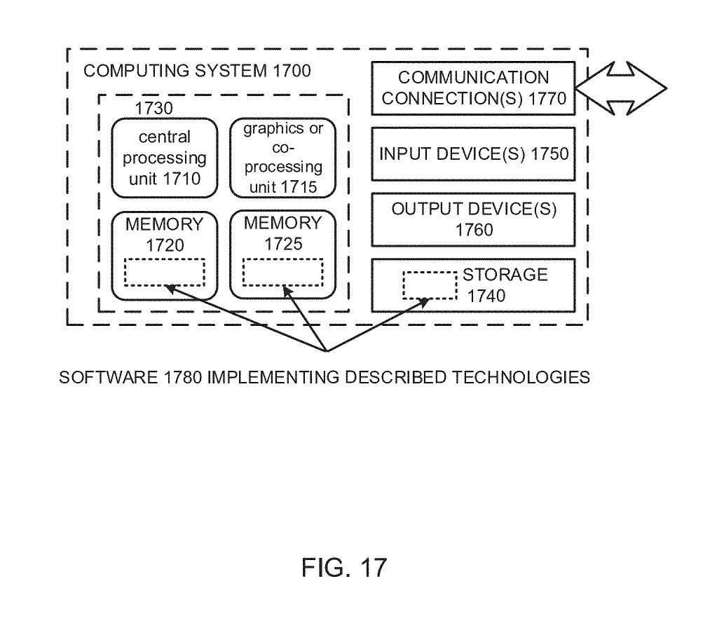

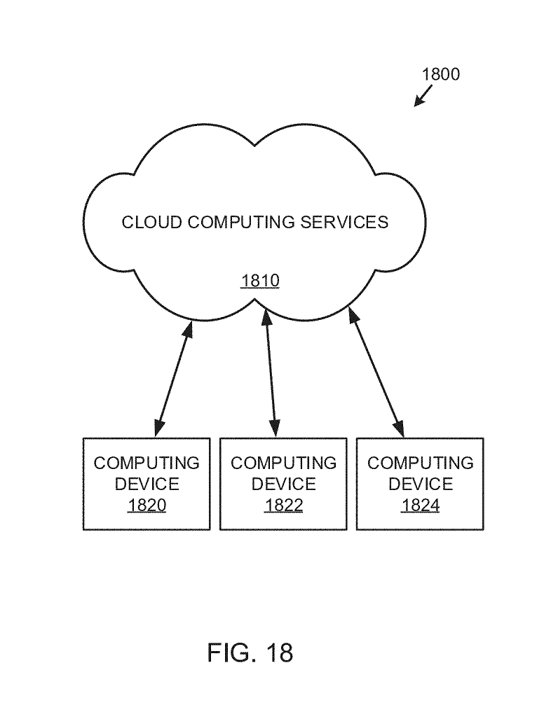

FIG. 17 depicts a generalized example of a suitable computing system 900 in which the described innovations may be implemented. However, in practice, the technologies described herein can be targeted to specialized neuromorphic hardware as described herein. The computing system 900 is not intended to suggest any limitation as to scope of use or functionality, as the innovations may be implemented in diverse general-purpose or special-purpose computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, solid state drives, etc.), or some combination of the two, accessible by the processing unit(s). The memory 920, 925 can store software 980 implementing one or more innovations described herein, in the form of computer-executable instructions suitable for execution by the processing unit(s).

The computing system 900 can comprise one or more neuromorphic processing units 918 as described herein. Such neuromorphic processing units 918 can work in conjunction with or replace the central processing units 910.

A computing system may have additional features. For example, the computing system 900 includes storage 940, one or more input devices 950, one or more output devices 960, and one or more communication connections 970. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 may be removable or non-removable, and includes magnetic disks, magnetic tapes or cassettes, solid state drives, CD-ROMs, DVDs, or any other medium which can be used to store information in a non-transitory way and which can be accessed within the computing system 900. The storage 940 can store instructions for the software 980 implementing one or more innovations described herein.

The input device(s) 950 may be a touch input device such as a keyboard, mouse, pen, or trackball, a voice input device, a scanning device, or another device that provides input to the computing system 900. For video encoding, the input device(s) 950 may be a camera, video card, TV tuner card, or similar device that accepts video input in analog or digital form, or a CD-ROM or CD-RW that reads video samples into the computing system 900. The output device(s) 960 may be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The computing system 990 can comprise one or more neuromorphic hardware devices 990 as described herein. Such devices can be separate from or incorporate the neuromorphic processing units 918, or both.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 7—Example Cloud Computing Environment

FIG. 10 depicts an example cloud computing environment 1800 in which the described technologies can be implemented. The cloud computing environment 1800 comprises cloud computing services 1810. The cloud computing services 1810 can comprise various types of cloud computing resources, such as computer servers, data storage repositories, networking resources, etc. The cloud computing services 1810 can be centrally located (e.g., provided by a data center of a business or organization) or distributed (e.g., provided by various computing resources located at different locations, such as different data centers and/or located in different cities or countries).

The cloud computing services 1810 are utilized by various types of computing devices (e.g., client computing devices), such as computing devices 1820, 1822, and 1824. For example, the computing devices (e.g., 1820, 1822, and 1824) can be computers (e.g., desktop or laptop computers), mobile devices (e.g., tablet computers or smart phones), or other types of computing devices. For example, the computing devices (e.g., 1820, 1822, and 1824) can utilize the cloud computing services 1810 to perform computing operators (e.g., data processing, data storage, and the like).

### Example 8—Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media can include any tangible media that can be accessed within a computing environment (e.g., one or more optical media discs such as DVD or CD, volatile memory components (such as DRAM or SRAM), or nonvolatile memory components (such as flash memory, solid state drives, or magnetic media such as hard drives)). By way of example and with reference to FIG. 17, computer-readable storage media include memory 1720 and 1725, and storage 1740. The term computer-readable storage media does not include signals and carrier waves. In addition, the term computer-readable storage media does not include communication connections (e.g., 1770).

For example, input circuits, neuron circuits and synapse circuits, as described herein, can be emulated and/or simulated using computer-executable instructions executed on traditional computing hardware.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

The disclosed technology is not limited to any specific computer language or program. For instance, the disclosed technology can be implemented by software written in C++, Java, Perl, JavaScript, assembly language, or any other suitable programming language. Likewise, the disclosed technology is not limited to any particular computer or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technologies may be applied, it should be recognized that the illustrated embodiments are examples of the disclosed technologies and should not be taken as a limitation on the scope of the disclosed technologies. Rather, the scope of the disclosed technologies includes what is covered by the scope and spirit of the following claims.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method of customizing a computing environment, comprising:
providing a browser-based application to a user;
receiving instructions from the user via the browser-based application to define a custom logical data object;
defining the custom logical data object in a backend in accordance with the instructions; and
generating a user interface comprising the custom logical data object within the browser-based application.

2. The method of claim 1, wherein the custom logical data object can comprise a node, at least one sub-node and at least one field.

3. The method of claim 1, further comprising defining an action associated with the at least one custom logical data object.

4. The method of claim 1, further comprising receiving instructions via the browser-based application to query a database and expose fields of the custom logical data object.

5. The method of claim 1, further comprising defining at least one of an approval process and a notification rule associated with the custom logical data object.

6. The method of claim 1, further comprising automatically associating a data source for the custom logical data object based on instructions received via the browser-based application.

7. The method of claim 1, further comprising automatically generating a web service associated with the logical data object based on instructions received via the browser-based application.

8. The method of claim 1, further comprising associating the custom logical data object with another logical data object representing an organization unit.

9. The method of claim 1, further comprising activating the custom logical data object.

10. The method of claim 9, further comprising assembling the custom logical data object in the backend.

11. The method of claim 10, further comprising downloading the custom logical data object in the backend.

12. One or more computer readable media storing instructions that, when executed by one or more processors, cause the one or more processors to perform a method, the method comprising:
receiving a request made via a web application with a user interface to generate a new logical data object;
defining the new logical data object in a system backend according to parameters specified via the web application; and
generating a new user interface element corresponding to the new logical data object in the same user interface.

13. The one or more computer-readable media of claim 12, further comprising automatically associating a data source for the new logical data object based on instructions received via the web application.

14. The one or more computer-readable media of claim 12, further comprising automatically generating a web service associated with the logical data object based on instructions received via the browser-based application.

15. The one or more computer-readable media of claim 12, further comprising downloading the new logical data object from a source tenant into a zip file and uploading the zip file in a target tenant.

16. The one or more computer-readable media of claim 15, wherein downloading the new logical data object from the source tenant is triggered from a selection made in the user interface of the web application.

17. The one or more computer-readable media of claim 15, wherein downloading the new logical data object comprises configuring the new logical data object for deployment in multiple customer systems.

18. The one or more computer-readable media of claim 15, wherein downloading the new logical data object comprises configuring the new logical data object for deployment in a single customer system.

19. The one or more computer-readable media of claim 12, wherein the new logical data object can comprise a node, at least one sub-node and at least one field.

20. A browser-based tool accessible from a customer system comprising a user interface configured to receive input to define a custom logical data object in a source system backend connected to the customer system and to enable the custom logical data object in the customer system.
